(19) United States
(12) Patent Application Publication
(10) Pub. No.: US 2015/0220977 A1
(43) Pub. Date: Aug. 6, 2015

(54) CAMPAIGN BUDGET CONTROLS VIA USER CONFIGURABLE LINE SPECIFICATIONS

(71) Applicant: Apple Inc., Cupertino, CA (US)

(72) Inventors: Mehul K. Sanghavi, Sunnyvale, CA (US); Fan Yang, Cupertino, CA (US); Jeffrey Michael Banister, Bedford, MA (US)

(73) Assignee: Apple Inc., Cupertino, CA (US)

(21) Appl. No.: 14/170,028

(22) Filed: Jan. 31, 2014

(51) Int. Cl. G06Q 30/02

(52) U.S. Cl. CPC G06Q 30/0249

(57) ABSTRACT

Systems, methods, and computer-readable storage media for providing advertisers with a mechanism to dynamically adjust budget constraints in order to take into account the advertisers' preferences for targeting users associated with specific dimensions within the segments targeted by a campaign. In particular, advertisers can specify a line specification that sets forth soft and hard constraints, where the hard constraints set caps for spend and the soft constraints set forth desired range of spend for categories in one or more dimensions and a relative importance of the spend in each category. The line specification can then be used to derive spending preferences that can be used to guide how spend is allocated over time.

### TECHNICAL FIELD

The present technology pertains to control of campaigns for delivery of invitational content, and more specifically pertains to utilization of a user-configurable line specification to control campaign budgets.

### BACKGROUND

Mobile advertising is widely used by advertisers to market their products via mobile devices. Given the widespread availability of mobile devices, mobile advertising can be an extremely effective way for advertisers to reach a wide mass of potential customers and induce numerous users to purchase their products. By targeting mobile users with effective mobile advertisements, advertisers can yield large financial returns from their mobile advertisements.

In general, advertisers establish a campaign by specifying characteristics of the users they wish to target with their advertisements and an overall budget for the campaign. Advertisements are then delivered to users until the budget for the campaign is spent. In some cases, an advertiser may wish to target specific dimensions, i.e., users with particular user characteristics. In general, this is accomplished by providing a line or ad order that specifies a spend amount, relative to the overall budget, for targeting the particular dimension.

While the use of lines or ad orders is common place, they are not without difficulties. In particular, once such lines or ad orders are in place and the advertiser needs to implement changes, significant intervention is typically required to go in and adjust the line or ad order. If multiple changes are needed in a short period of time, the amount of intervention required can be burdensome. Moreover, variations in traffic can greatly affect spend patterns. Therefore, if the maximum budgets in the line or ad order are set incorrectly or are set at levels that a daily spend amount cannot accommodate, the advertiser can lose out on valuable opportunities to serve their advertisement. Even worse, the advertiser may fall short of their campaign goals unless there is active intervention to correct the line or ad order.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to provide greater control of campaign budgets via user-configurable and dynamically adjustable line specifications. In particular, the approaches set forth herein allow an advertiser or other content provider associated with a campaign to provide, at any time, a line specification that set forth hard constraints and soft constraints for one or more dimensions for a particular period of time (e.g., a day). The hard constraints can specify maximum spend allowed for the dimensions. The soft constraints can be utilized to specify a range of spend desired for categories in the dimensions, as well as rank or relative importance of the various categories. Disclosed are systems, methods, and non-transitory computer-readable storage media for using these line specifications and they can be used to accomplish two tasks. First, they can be used to determine whether or not a campaign is suitable for servicing a request. Second, the line specification can be utilized to determine whether a campaign should service a request.

A determination of the suitability of a campaign for a request involves identifying a request corresponding to a segment in n-dimensional space associated with a campaign, such as a request for delivering an item of invitational content to a user terminal. Next, a line specification associated with the campaign is obtained, where the line specification includes a plurality of soft spending constraints for dimensions in the n-dimensional space and where each of the plurality of soft spending constraints defining a rank, a minimum spend, and a maximum spend for a categories in the dimensions. Afterwards, it is determined whether the campaign is suitable for servicing the request based on the line specification and a current spend for the campaign. Finally, in response to determining that the campaign is suitable for servicing the request, the campaign is added to a list of candidate campaigns which can then be used to service the request

Servicing of the requests involves determining whether a spend of a campaign should be allocated to a request. In the disclosed technology, this involves receiving a request for invitational content from a user terminal and the identifying of candidate campaigns suitable for servicing the request. Next, a one of the candidate campaigns can be selected for potentially servicing the request. Thereafter, a determination is made as to whether to allocate a spend of the selected campaign for the request based one the line specification and a current spend for the selected campaign. As previously noted, the line specification can include a plurality of soft spending constraints for dimensions in the n-dimensional space and optionally hard constraints, where each of the plurality of soft spending constraints defining a rank, a minimum spend, and a maximum spend for categories in the dimensions. Finally, in response to determining to allocate the spend, the request is serviced using the selected campaign. Otherwise, the process is repeated with a different campaign until a spend can be allocated to the request.

In some configurations, a target group specification can be provided for a campaign, where the target group specification identifies multiple target groups, each specifying a line specification and a portion of a total spend to be allocated to each group. These target groups specification can be utilized to evaluate different line specifications for a campaign.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates a first exemplary embodiment of an interface for providing campaign budget controls;

FIG. 3 illustrates a second exemplary embodiment of an interface for providing campaign budget controls;

FIG. 4 illustrates an exemplary method embodiment;

FIG. 5 illustrates an exemplary method embodiment; and

FIG. 6A and FIG. 6B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology is directed to providing advertisers with a mechanism to dynamically adjust budget constraints in order to take into account the advertisers' preferences for targeting users associated with specific dimensions within the segments targeted by a campaign. More specifically, a mechanism which takes into account the incoming supply of requests for advertisements (traffic) on a given day (or other time period) and which also allows for a more even spread of the allowed spend for a campaign for the day (or other time period).

The present disclosure contemplates that one aspect of this dynamic adjustment of budget constraints involves an advertiser providing, in a line specification, a set of constraints that specify, for specific dimensions, a minimum and a maximum spend per time period of interest. In some configurations, the advertiser can specify a sliding scale/range that can adjust itself based on a set of rules set forth by the advertiser. A content delivery system can then utilize this set of constraints to determine if and when requests are serviced using content associated with the campaign.

The general methodology of the disclosed technology can be illustrated with the following examples. Say there are dimensions where the advertiser would want to setup their primary media targeting and other dimensions where they would like to expand to for reach and other experimentation. In the disclosed technology, the advertiser can specify this information to a content delivery system by specifying, in a line specification, hard constraints for the primary dimensions and soft or sliding scale constraints for the secondary dimensions.

For example, an advertiser can select gender, male (M) and female (F), to be a primary dimension to be associated with hard constraints. In one exemplary configuration, an advertiser can specify a hard constraint of 40% for M. Thus, the content delivery system will allow for any traffic with gender M (and other constraints met) to be serviced using by the campaign up until 40% of the allowable spend (total or for the line, depending on the setup) has been met. In the meantime, gender F can have no hard constraint. Thus, the content delivery system will allow any traffic for gender F (and other constraints met) up to 100% of the spend allocated for the day or time period of interest. It should be noted that since the gender M is a constraint and not an actual goal value, the spend can vary between different time periods of interest, such as day to dat. So for any particular day, the spend can vary significantly. For example, spends for different days can be F—70, M—30, F—99, M—1, etc. . . . . In an ideal situation, the female gender spend will be in the range of 60 to 100, the cap on the male gender spend is only intended to keep the overall spend on that dimension under control as female gender is essentially what the marketer wants in this case. That is, the advertiser is really looking for preferably targeting gender F. Thus, by limiting the spend exposure of gender M, the advertiser is able to meet their general goal.

As noted above, in addition to hard constraints, the disclosed technology also contemplates the use of soft constraints in the line specification. For example, an advertiser may specify creative specifications, such as a banner size (e.g., 100×100, 200×200, and 300×300). In this case, the advertiser can have a general goal to would like to get advertisement exposure in the highest banner size possible at all time. However, since the 300×300 banner size may be sought after by other advertisers as well, there may be a supply constraint. To address this problem, the advertiser can specify spend range for one or more of the banner specifications. Moreover, the present disclosure contemplates that the advertiser can combine such soft constraints with a hard budget constraint. For example, the set of constraints can be specified in a line specification as:
100×100—hard, 0%.
200×200—soft—30%-80%, Tier-2
300×300—soft—30%-80%. Tier-1
   Based on this set on constraints, the content delivery system will know to not spend for any incoming requests associated with a 100×100 banner due to the hard constraint specified. For the other two banner sizes, the soft constraints specified give the content delivery system a minimum target for each banner size, plus license to spend up to the designated amounts.

Moreover, the present disclosure also contemplates providing a tiered or ranking system for the soft constraints. That is, based on the tiering or ranking set forth in the line specification, the content delivery system will try to lean towards more spending against the 300×300 dimension versus the 200×200. In a best case scenario, the advertiser will meet their max budget cap of 80% given their preference for the largest banner size. In the worst case scenario, the advertiser will get 80% of 200×200 and 20% of 300×300. This too is acceptable since this targeting dimension is set with a soft constraint.

These two examples illustrate the power of the disclosed technology to shift the operationally heavy line or ad order targeting to a more dynamically placed line specification. However, the present disclosure contemplates that these concepts can be pushed much further in cases where there is significant variation in terms of traffic patterns and in terms of variability of the targeting dimensions itself.

In particular, the advertiser can be given a two-tier constraint mechanism where a line specification can be provided for a campaign which contains the hard constraints and the line contains a multitude of ad orders, all of which contain soft constraints. The sum total of the constraints at the ad order level can easily add up to more than 100 and is intentionally designed to be so. Thus, a content delivery system has sufficient instruction to spend at its own pace with a higher degree of flexibility, but without breaching the line totals. For example, the set of constraints can be specified in the line specification as:
Hard constraints for gender targeting.
   F—20, M—No cap.
AO 1 setup: Soft constraint for device targeting.
   Tablet—40-90% Tier-1
   Smartphone—20-70% Tier-2
AO 2 setup: Soft constraint for household income (HHI) targeting.
   Low HHI band—10-30% Tier-3
   Medium HHI band—10-40% Tier-2
   High HHI band—20-90% Tier-1
      AO 1 and AO 2 are serving against their respective target ranges on incoming traffic, but each ad order will stop serving when associated hard or soft constraints have been met. The sum total of all served traffic by all ad orders combined will not exceed the 20% cap set for F gender.

The present disclosure also contemplates that an alternative method of specifying constraints is via the use of target groups. In the present technology, a target group can be defined by associating various spend levels with a group of select dimensions. These constraint driven target groups can be used to control traffic further by treating each group as an A/B testing bucket. An exemplary set of target groups is provided below:
a. 20% to Group 1: Gender (M:30; F:None)+HHI Bands (Low Band: 40%; High Band: None)
b. Remaining to Group 2: Gender (M:50; F:None)+HHI Bands (Low Band: 50%; High Band: None)
c. 20% to Group 3: Gender (M:30; F:None)+HHI Bands (Low Band: 40%; High Band: None)+Connection Type (Edge:10%; GPRS:10%, Wifi:None)
d. 10% to Group 4: Gender (M:30; F:None)+HHI Bands (Low Band: 40%; High Band: None)+Connection Type (Edge:0%; GPRS:0%, Wifi:None)
   Each of these groups can get a portion of the line budget as noted above. Although target groups can be utilized to target particular segments, target groups can also be used to evaluate the performance of a campaign or even to tune the campaign. For example, a group performing the best will see an increase in the amount of budget it receives from the parent line. Thus, an advertiser can put in play several such groups to evaluate performance before settling on one group for the remainder of the campaign or before adjusting the constraints within one or more groups.

The present disclosure contemplates that the process of adjusting the spend for the target groups. For example, the sets of target groups can be utilized to define a group specification consisting of a number of groups, each setting forth a line specification and a portion of the total spend to be allocated to each group. The line specification in each group can then specify a spend, relative to the portion of spend allocated to the group. Thereafter, the content delivery system can manage the group specification automatically.

In one configuration, the content delivery system can be configured to monitor the spend for each group and evaluate the group spend with respect to some high performance criteria. For example, a measure can be obtained that indicates how well a spend for a target group is being substantially met within a time period. If the measure meets a threshold value or criteria, the group can be identified as a high performance group. Thereafter, the campaign can be automatically adjusted to utilize solely the target groups identified as high performance groups. This process can also include automatically readjusting the portion of the total spend for the two groups according to pre-defined rules. For example, the proportion of spend between the groups can be maintained.

In another configuration, the group spend can be evaluated with respect to a low performance criteria and adjustments can be automatically provided to improve the performance of these groups. For example, a measure can again be obtained that indicates how well spend for a target group is being substantially met within a time period. If the measure fails to meet a threshold value or criteria, the group can be identified as a low performance group. Thereafter, the campaign can be automatically adjusted to adjust the line specification of the identified low performance groups. For example, this can entail identifying, from high performance groups, the categories of dimensions associated with higher performance and adjusting the line specification accordingly. Additionally, this process can also include automatically readjusting the portion of the total spend for the groups.

Although the examples above are limited to certain dimensions for hard constraints, soft constraints, and values and rankings for each, the disclosed technology is not limited in this regard. Rather, the present disclosure contemplates that a line specification and ad orders can be assembled using any number and combinations of dimensions.

Further, as noted above, the present disclosure contemplates that the caps, ranges, and ranking provided need not be static and can vary based on any number of factors. For example, variability in advertisement pricing, ranking or prioritization of different campaigns, and performance of particular campaigns, to name a few.

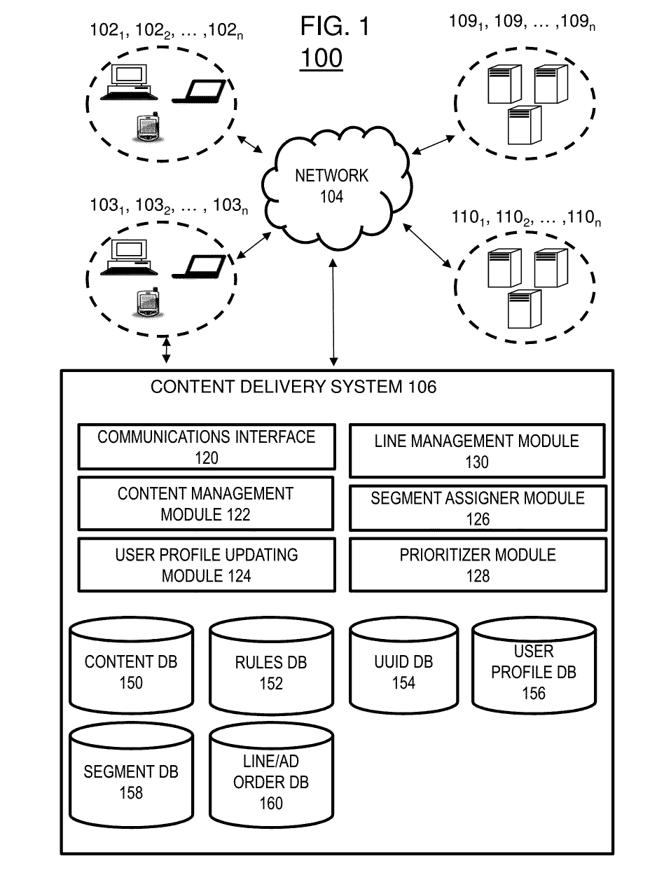

Prior to discussing further details regarding the present technology, a brief introductory description of an exemplary configuration of devices and a network is disclosed herein. A detailed description of the various aspects of the present technology will then follow. These variations shall be described herein as the various embodiments are set forth. The disclosure now turns to FIG. 1.

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery system 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102ᵢ. A subsequent content package can include one or more items of invitational content that can be presented to a user of the user terminal 102ᵢ while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102ᵢ. However, in some cases, the content management module 122 can be configured to retrieve content directly from content providers 109 and 110 if the metadata associated with the data in the content database 150 appears to be outdated or corrupted.

As described above, content maintained by the content providers 109 and 110 can be combined according to a predefined arrangement between the two content providers, which can be embodied as a set of rules. In an arrangement where the content delivery system 106 assembles the content package from multiple content providers, the assembly rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including invitational content, the rules database 152 can specify rules for selecting one of the secondary providers 110. The rules can also specify how to select specific content from the selected one of secondary providers 110 to be combined with the content provided by one of primary providers 109. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 156 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

While the content delivery system 106 is presented with specific components, it should be understood by one skilled in the art, that the architectural configuration of system 106 is simply one possible configuration and that other configurations with more or less components are also possible.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

To implement the various embodiments of the present technology, the content delivery system 106 can include additional components. As noted above, one aspect of the disclosed technology is providing a mechanism that enables content providers, such as advertisers, to define constraints for a campaign by specifying lines and ad orders as described above. Accordingly, content delivery system 106 can include a line management module 130 to receive and manage such constraints.

In particular, the present disclosure contemplates that a content delivery system would receive line request or specifications from one of user terminals 103₁, 103₂, . . . , 103ₙ (collectively “103”) that are in direct and/or indirect (e.g., via network 104) communications with a content delivery system 106. The line specifications can then processed and stored by the line management module 130 in line/ad order database 160. The line specification in line/ad order database 160 can then be accessed by content management module 122 to process and service requests for invitational content.

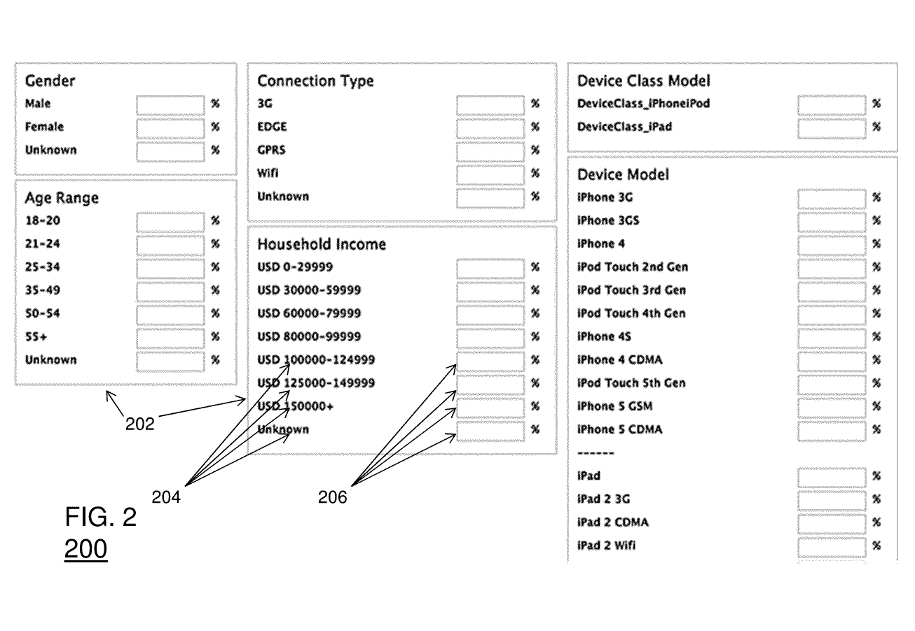

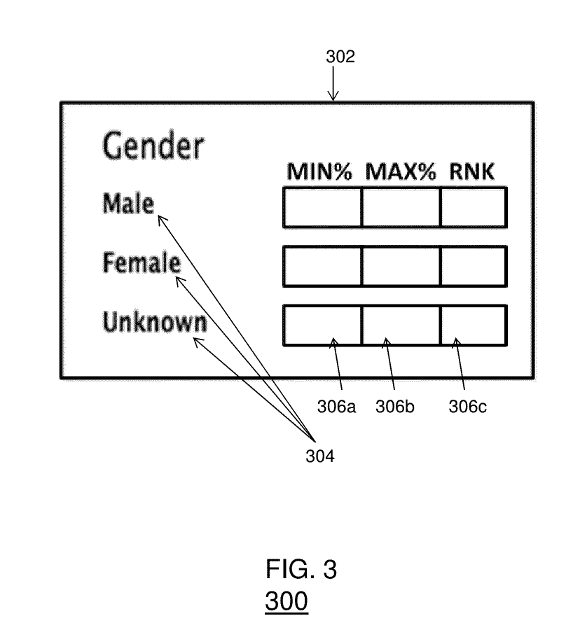

The present disclosure contemplates that the line specifications can be provided in a variety of ways. In some configurations, a listing of text representing the line, such as those shown above, can be provided and processed for storage. In other configurations, the line specification can be input via a graphical user interface provided via a management application associated with the content delivery system 106. The data collected via this graphical user interface can then be processed for storage. An exemplary configuration for such an interface is illustrated with respect to FIGS. 2 and 3.

FIG. 2 illustrates an exemplary interface 200 for specifying hard constraints for various dimensions. As shown in FIG. 2, interface 200 provides a number of dimensions 202 for constraints, including gender, age range, connection type, household income, device class model, and device model. The dimensions and categories are provided by way of example only and the present disclosure contemplates more or less categories than shown, including completely different sets of dimensions and categories. For each of the dimensions 202, multiple categories 204 are provided, along with corresponding input elements 206. Thus, in operation, the hard constraints can be specified by adding the value of the hard cap for each category. Note that the values for the multiple categories need not add up to exactly 100. In fact, as noted above, these can add up to greater than 100. Further, if no cap is desired, the value can be left blank or set to 100 for a category in a dimension, depending on the configuration of an associated content delivery system.

Specification of soft constraints can be provided in a similar fashion, as shown in FIG. 3. FIG. 3 illustrated a portion of an exemplary interface 300 for specifying soft constraints for categories in one dimension. However, interface 300 can include additional dimensions and categories in a manner similar to that shown in FIG. 2. In particular, FIG. 3 illustrates a dimension 302 associated with gender. Similar to the dimensions in FIG. 2, the dimension 302 also specifies multiple categories 304. However, instead of a single input element 206, each of the constraints includes multiple input elements 306a-306c, as shown in FIG. 3. These include a minimum percentage input element 306a, a maximum percentage input element 306b, and a rank input element 306c.

The maximum percentage input element 306b, similar to the input element 206, can be used to specify a cap for the spend for the dimension in the category, similar to a hard cap. The minimum percentage input element 306a can be utilized to specify a target minimum spend for the category the dimension. The rank input element 306c can be used to specify an importance of a particular category in a dimension with respect to other categories. The use of these values will be discussed in greater detail below.

Although FIGS. 2 and 3 are illustrated with input elements configured as text boxes for inputting values via a keyboard, keypad, or the like, the present disclosure contemplates that other types of input elements can be utilized for inputting the values for the hard caps. These can include, but are not limited to, drop-down lists, list boxes, combo boxes, check boxes, radio buttons, cycle buttons, and sliders.

Moreover, although FIGS. 2 and 3 are illustrated with specifying percentages of spend, the present disclosure contemplates that constraints on particular categories can be specified in a number of ways. For example, the percentages can be with respect to requests, traffic, or the like. In another example, the constraints can specify actual budget amounts. However, the embodiments of the disclosed technology are not limited to any particular scheme or method for specifying constraints.

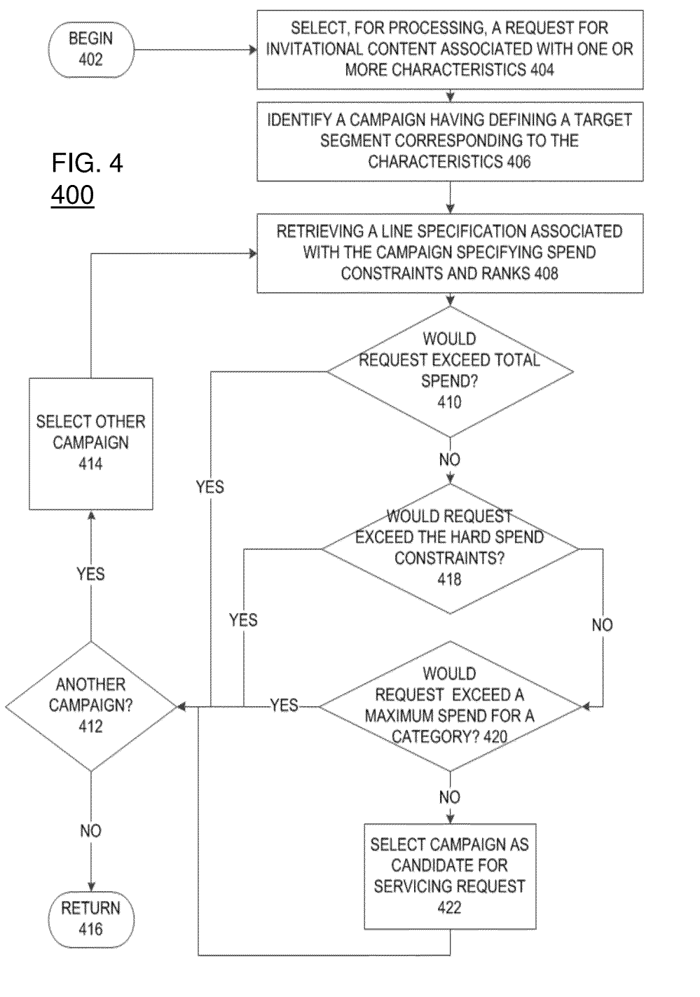

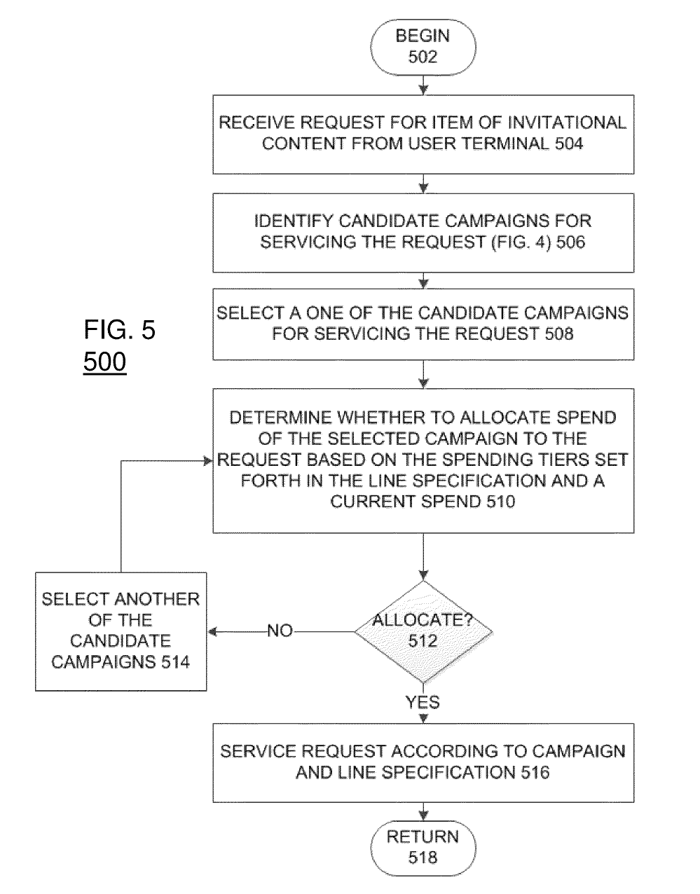

Referring back to FIG. 1, once the line specifications are received, processed, and stored at the content delivery system 106, they are then available for use in controlling the delivery of invitational content for an associated campaign. As described above, the content management module 122, along with other components in the content delivery system 106, can receive a request for invitational content, determine campaigns suitable for providing the invitational content, and select the campaign and invitational content based on selection rules. In the disclosed technology, an additional layer of control is provided. In particular, the disclosed technology allows the content delivery system 106 to determine campaigns suitable for the request and deliver invitational content from the campaigns, taking into consideration associated line specifications and current spend for the various campaigns. These processes are illustrated with respect to FIGS. 4 and 5.

Turning first to FIG. 4, there is disclosed a flowchart of steps in an exemplary method 400 for determining campaigns suitable for servicing a request according to the disclosed technology. Method 400 begins at step 402 and continues to step 404. At step 404 a request for invitational content to be processed is selected. The request can be associated with one or more characteristics in any number of dimensions in k-space, such as channel characteristics, spatial-temporal characteristics, behavioral characteristics, and demographic characteristics, as previously discussed.

In response to the receipt of the request at step 404, the method 400 proceeds to step 406 where a campaign is identified which is designed to target a segment of k-space corresponding to the characteristics associated with the request. For example, this can be a target segment in segment database 158 associated with the user originating the request. In some configurations, an exact match can be required. In other configurations, if a majority of the characteristics match, a close match can be determined to occur and the campaign can be selected. However, the present disclosure contemplates that the degree of match required between the characteristics and the target segment can vary campaign to campaign or even segment to segment.

After a campaign is identified in step 406, the method 400 proceeds to step 408 to begin a determination of whether the line specification may prevent consideration of the campaign for the request, even though it matches a target segment. First, at step 408, any line specifications associated with the campaign are retrieved. The line specification can be obtained, for example, from line/ad order database 160, as previously discussed with respect to FIG. 1. The present disclosure also contemplates that there may be more than one line specification for a campaign. For example, for each target segment, a different line specification can be provided. Accordingly, the line specification retrieved at step 408 can include be a line specifications for the campaign, the target segments, or both.

Once the line specification(s) is retrieved at step 408, the method 400 can perform, before, after, or contemporaneously with step 408, step 410. At step 410, a determination can be as to whether servicing the request would result in the total spend for a campaign for a time period of interest to be exceeded. If such servicing would cause the total spend to be exceeded, then the campaign cannot be used for servicing the request. Rather, the method 400 determines whether or not another campaign with a suitable target segment exists at step 412, similar to step 406. If such a campaign exists, this campaign is selected at step 414 and the method 400 is repeated, starting at step 408. If no campaign exists, the method resumes previous processing at step 416 and returns a identification of suitable campaigns for the request.

In the event that servicing the request would not cause the total spend to be exceeded at step 410, the method 400 proceeds to step 418. At step 418, a determination is made as to whether servicing the request would cause the spend to exceed any hard constraints set forth in the line specification. If such servicing would cause the hard constraint to be exceeded, then the campaign again cannot be used for servicing the request and the method would proceed to step 412 and subsequent steps, as previously discussed. However, in the case that the hard constraint would not be exceeded, the method can proceed to step 420.

At step 420, a determination can then be made as to whether servicing the request according to the campaign or target segment associated with the line specification would cause a maximum spend for a category to be exceeded. That is, if the only way(s) to service the request, based on the campaign parameters, would result in any maximum constraint in the line specification to be exceeded, then the campaign again cannot be used for servicing the request and the method would proceed to step 412, as previously discussed. However, in the case that this maximum spend would not be exceeded, the method 400 can proceed to step 422 and the campaign can be selected as a candidate for servicing the request. Afterwards, the method 400 can proceed to step 412 and subsequent steps, as previously discussed.

Now turning to FIG. 5, there is disclosed a flowchart of steps in an exemplary method 500 for servicing a requests according to the disclosed technology. Method 500 begins at step 502 and continues to step 504. At step 504, a request for an item of invitational content is received from a user terminals. In response to such a request, candidate campaigns can be selected at step 506. In particular, the present disclosure contemplates that this process at step 506 can be performed according to the method set forth in FIG. 4. However, the present disclosure also contemplates that using similar methods that identifies candidate campaigns based on a line specification(s) for the campaign and a spend currently associated with each potential campaign for servicing the request.

Once the candidate campaigns are identified at step 506, the method can proceed to step 508. At step 508, a campaign for servicing the request can be selected. The selection at step 508 can be performed in accordance with conventional campaign selection methods. For example, the rules in rules database 152 can be applied to determine which of the candidate campaigns should be selected for serving the invitational content. However, it should be noted that due to the identification at step 506, the number of campaigns considered may be lower than the number of campaigns that would be normally considered. That is, identification at step 506 results in excluding any campaigns from consideration that would result in either a total allowable spend, a hard constraint, or a maximum soft constraint being exceeded.

After the candidate campaign is selected at step 508, a determination is made as to whether a spend of the campaign should be allocated to the request at step 510 and subsequent action is taken at step 512. In particular, the determination at step 510 can be based on the constraints in the line specification, the spending tiers or ranks provided in the line specification, and the current spend associated with the campaign. In according with the disclosed technology, there are several considerations associated with a determination of whether allocation should be performed.

One potential consideration is whether allocating spend to the request will cause a hard constraint to be exceeded. That is, if the spend for the category is restricted, allocation can only occur if spend is available for the category. In some configurations, as illustrated in FIG. 4, this can be part of the process of selecting candidate campaigns for serving the request. Alternatively or in addition to the processes of FIG. 4, this can also be part of the consideration at step 510.

Another potential consideration is whether a minimum spend for any of the categories has not yet been met. As noted above, the ranges set forth by the soft constraints in a line specification basically set forth ideal spend for the various categories. Thus, the line specification can also set forth that there can be some preference towards spend resulting in at least the minimum spend being met for each of the categories. For example, referring back to the exemplary line specification for the varying banner sizes (100×100—hard—0%; 200×200—soft—30%-80%, Tier-2; and 300×300—soft—30%-80%, Tier-1), this line specification indicates that there is a preference to try and reach a 30% spend level for each of the larger banner sizes. Thus, all other factors being equal, the line specification causes the content delivery system to, over time, allow allocation of spend for requests associated with either these two banner types in an attempt to try and meet the minimum spend for each.

An additional potential consideration is whether allocating spend to the request will cause a maximum spend for any category to be exceeded. In some configurations, as illustrated in FIG. 4, this can be part of the process of selecting candidate campaigns for serving the request. Alternatively or in addition to the processes of FIG. 4, this can also be part of the consideration at step 510. However, as the maximum spend for the category is not a restriction but a constraint, it is possible that the request can still be serviced. For example, referring to the banner example, if the spend for the 300×300 category is maxed out, allocation can only occur if servicing of the request can be accomplished based on a spend for a 200×200 category. Thus, spend may be allocated, but for only certain categories within a dimension.

A further potential consideration in allocating spend is consideration of the tiers or rankings associated with the various categories. As noted above with respect to the minimum spend, the line specification sets forth an ideal spend for the various categories over a time period of interest. However, as discussed above, certain categories in a dimension may be of greater importance to an advertiser than other categories. Accordingly, by allowing advertisers to provide spending tiers or ranking associated with the different categories in the soft constraints, this signals the content delivery system 106 to push the spend towards meeting the maximum spend for categories that are more highly ranked. For example, referring back to the banner example, 300×300 banners are associated with a higher ranking (Tier-1) than 200×200 banners (Tier-2). Thus, the content delivery system 106 can, over time, attempt to allocate spend preferentially to requests associated with 300×300 banners. Alternatively stated, if n number of requests associated with 300×300 banners and n number of requests associated with 200×200 banners, the content delivery system 106 will attempt to allocate to result in n−i number of requests associated with 300×300 banners being serviced and n−j number of requests being associated with 200×200 banners being services, so that j>i. However, since actual servicing is based on traffic, this is only a goal. Thus, it is possible that i ends up greater than or equal to j.

Although several exemplary considerations have been described above, the present disclosure contemplates that the considerations for different requests can vary over time and can include more or less than all of the considerations noted above. Further, the relative weight or importance of each of the considerations used in a determination can also vary from request to request. For example, the relative weight of a consideration can vary based on a performance of a campaign or a relative importance or priority of an advertiser or provider associated with a campaign. In another example, the line specification can specify how the relative importance of the consideration is to vary as a function of time, spend, or other factors.

At step 512, if the determination at step 510 results in no spend being allocated for the request, the method 500 proceeds to step 514. At step 514, another of the candidate campaigns is selected to potentially service the request and steps 510-514 are repeated until a campaign is found that can allocate spend to the request. That is, once the determination at step 510 results in spend being allocated to the request, the method proceeds from step 512 to step 516. At step 516, the request is then serviced according to the campaign and the line specification. The method 500 then proceeds to step 518 to resume previous processing, including repeating method 500.

For some cases, the present disclosure contemplates the considerations can be evaluated based on some type of scoring system. That is, for each consideration, a score can be generated that indicates a degree of compliance with the constraint. These scores can then be aggregated and compared to criteria to determine whether or not the request should be serviced. The present disclosure also contemplates that such scores can be weighted to reflect their relative importance. These weights can be fixed or can vary. The varying of the weights can be based on any number of factors, including the campaign, the campaign performance, the segment, a date, and a time, to name a few.

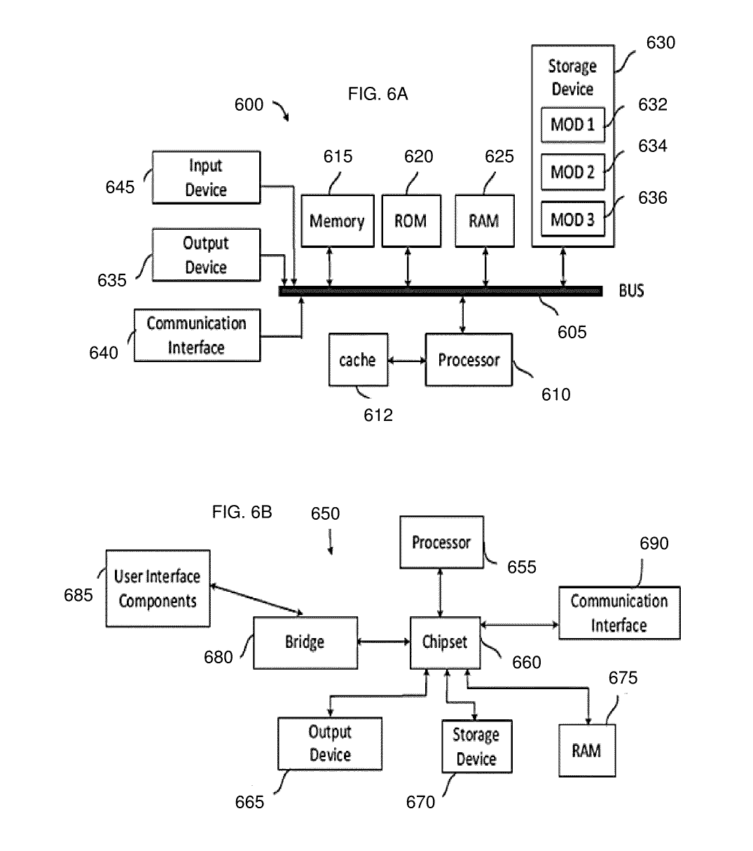

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

We claim:

1. A computer-implemented method comprising:
identifying a request corresponding to a segment in n-dimensional space associated with a campaign, the request comprising a request for delivering an item of invitational content to a user terminal;
obtaining at least one line specification associated with the campaign, the at least one line specification comprising a plurality of soft spending constraints for at least one dimension in the n-dimensional space, each of the plurality of soft spending constraints defining a rank, a minimum spend, and a maximum spend for a category in the at least one dimension;
determining whether the campaign is suitable for servicing the request based on the line specification and a current spend for the campaign;
in response to determining that the campaign is suitable for servicing the request, adding the campaign to a list of candidate campaigns; and
servicing the request using a one of the candidate campaigns.

2. The method of claim 1, wherein the determining comprises ascertaining that the campaign is suitable when servicing the request using the campaign would not exceed a total spend for the campaign and the request can be serviced using the campaign without causing one of the plurality of soft contrasts to be exceeded.

3. The method of claim 1, wherein the line specification further comprises at least one hard spending constraint associated with at least one other dimension in the n-dimensional space, and wherein the determining comprises ascertaining that the campaign is suitable when servicing the request using the campaign would not exceed the at least one hard spending constraint for the at least one other dimension.

4. The method of claim 3, wherein the at least one hard spending constraint is associated with only a portion of categories for the at least one other dimension.

5. The method of claim 1, wherein the at least one dimension is associated with any of channel characteristics, spatial-temporal characteristics, behavioral characteristics, and demographic characteristics.

6. The method of claim 1, wherein the at least one line specification is configured to vary based on at least one of an amount of time left in the campaign, an amount of spend left for the campaign, or a performance of the campaign.

7. A non-transitory computer-readable storage medium having stored therein instructions which, when executed by a processor, cause the processor to perform operations comprising:
receiving a request for invitational content from a user terminal;
identifying one or more candidate campaigns suitable for servicing the request;
selecting one of the candidate campaigns to yield a selected campaign;
determining whether to allocate a spend of the selected campaign for the request based at least one line specification and a current spend for the selected campaign, the at least one line specification comprising a plurality of soft spending constraints for at least one dimension in the n-dimensional space, each of the plurality of soft spending constraints defining a rank, a minimum spend, and a maximum spend for each of a plurality of categories in the at least one dimension;
in response to determining to allocate the spend to the request, servicing the request using the selected campaign; and
in response to determining not to allocate the spend to the request, repeating the determining using another one of the candidate campaigns.

8. The computer-readable storage medium of claim 7, wherein the determining comprises:
ascertaining whether servicing the request using the selected campaign furthers a plurality of spending goals for the campaign derived from the current spend and the at least one line specification; and
in response to ascertaining that that servicing of the request furthers the plurality of spending goals, selecting to allocate the spend to the request.

9. The computer-readable storage medium of claim 8, wherein the ascertaining comprises:
computing scores for the request with respect to each of the plurality of spending goals indicating a degree to which the servicing of the request will further each of the plurality spending goals, and
concluding that the servicing of the request furthers the plurality of spending goals when an aggregate of the scores meets a pre-defined criteria.

10. The computer-readable storage medium of claim 9, wherein the scores are weighted.

11. The computer-readable storage medium of claim 8, wherein at least one of the plurality of spending goals is to meet the minimum spend for each of the plurality of categories associated with the request without exceeding a total spend.

12. The computer-readable storage medium of claim 8, wherein at least one of the plurality of spending goals is to meet the maximum spend for at least one of the plurality of categories associated with the request without exceeding a total spend.

13. The computer-readable storage medium of claim 11, wherein the at least one of the plurality of categories is associated with the rank that is highest.

14. The computer-readable storage medium of claim 7, wherein the at least one line specification further comprises at least one hard spending constraint associated with at least one other dimension in the n-dimensional space, and wherein at least one of the plurality spending goals is to meet the at least one hard constraint without exceeding a total spend.

15. A content delivery system comprising:
a communications interface for receiving a request for invitational content from a user terminal;
at least one processor; and
a computer-readable storage medium having stored therein instructions which, when executed by the processor, cause the processor to perform operations comprising:
identifying one or more candidate campaigns suitable for servicing the request;
selecting one of the candidate campaigns to yield a selected campaign;
determining whether to allocate a spend of the selected campaign for the request based at least one line specification and a current spend for the selected campaign, the at least one line specification comprising a plurality of soft spending constraints for at least one dimension in the n-dimensional space, each of the plurality of soft spending constraints defining a rank, a minimum spend, and a maximum spend for each of a plurality of categories in the at least one dimension;
in response to determining to allocate the spend to the request, servicing the request using the selected campaign; and
in response to determining not to allocate the spend to the request, repeating the determining using another one of the candidate campaigns.

16. The system of claim 15, wherein the identifying comprises selecting a potential campaign with a segment in the n-dimensional space corresponding to the request, obtaining at least one line specification associated with the potential campaign, and adding the potential campaign to the candidate campaigns if servicing the request using the potential campaign would not exceed a total spend for the potential campaign or a constrain in the at least one line specification associated with the potential campaign.

17. The system of claim 15, wherein the determining comprises:
ascertaining whether servicing the request using the selected campaign furthers a plurality of spending goals for the campaign derived from the current spend and the at least one line specification; and
in response to ascertaining that that servicing of the request furthers the plurality of spending goals, selecting to allocate the spend to the request.

18. The system of claim 17, wherein at least one of the plurality of spending goals is to meet the minimum spend for each of the plurality of categories associated with the request without exceeding a total spend.

19. The system of claim 17, wherein at least one of the plurality of spending goals is to meet the maximum spend for at least one of the plurality of categories associated with the request without exceeding a total spend.

20. The system of claim 19, wherein the at least one of the plurality of categories is associated with the rank that is highest.

21. The system of claim 15, wherein the at least one line specification further comprises at least one hard spending constraint associated with at least one other dimension in the n-dimensional space, and wherein at least one of the plurality spending goals is to meet the at least one hard constraint without exceeding a total spend.

22. A computer-implemented method, comprising:
receiving a request for invitational content from a user terminal;
selecting a campaign having a target segment in n-dimensional space corresponding to characteristics associated with the request;
determining whether allocating a spend of the selected campaign for the request will further a plurality of spending goals derived from at least one line specification and a current spend for the selected campaign, the at least one line specification comprising a least one hard spending constraint for at least one dimension in the n-dimensional space and at least one soft spending constraint for at least other dimension in the n-dimensional space, the at least one soft spending constraint defining a rank, a minimum spend, and a maximum spend for each of a plurality of categories in the at least other dimension;
in response to determining the allocating the spend of the selected campaign for the request will further the plurality of spending goals, servicing the request using the selected campaign; and
in response to determining the allocating the spend of the selected campaign for the request will not further the plurality of spending goals, repeating the determining with another campaign.

23. A computer-implemented method comprising:
identifying a request corresponding to a segment in n-dimensional space associated with a campaign, the request comprising a request for delivering an item of invitational content to a user terminal;
obtaining a target group specification comprising a plurality of target groups and a group spending constraint corresponding to each of the plurality of target groups, each of the plurality of target groups comprising a line specification comprising a plurality of spending constraints for at least one dimension in the n-dimensional space, each of the plurality of spending constraints defining an allowable spend of the corresponding group spending constraint for a category in the at least one dimension;
determining whether the campaign is suitable for servicing the request based on the target group specification and a current spend for the campaign;
in response to determining that the campaign is suitable for servicing the request, adding the campaign to a list of candidate campaigns; and
servicing the request using a one of the candidate campaigns.

24. The method of claim 23, further comprising:
detecting at least one of the plurality of target groups meeting a high performance criteria; and
replacing the target group specification with a replacement specification comprising the at least one of the plurality of target groups.

25. The method of claim 23, further comprising:
identifying at least one of the plurality of target groups meeting a low performance criteria; and
adjusting the group spending constraint corresponding to each of the plurality of target groups in favor of the at least one of the plurality of target groups.
